(19) United States
(12) Patent Application Publication
(10) Pub. No.: US 2004/0090556 A1
(43) Pub. Date: May 13, 2004

(54) Video output signal format determination in a television receiver

(76) Inventors: John Kamieniecki, Lafayette Hill, PA (US); Joseph F. Halgas JR., Huntingdon Valley, PA (US); Robert Simons, Lansdale, PA (US); Jack Birnbaum, Southampton, PA (US); David E. Zeidler, Warrington, PA (US); Matthew Piacentino, Harleysville, PA (US)

Correspondence Address: Paul Bawel, General Instrument Corporation, Law Department, 101 Tournament Drive, Horsham, PA, 19044, US

(21) Appl. No.: 10/292,306

(22) Filed: Nov. 12, 2002

(51) Int. Cl. H04N 5/46

(52) U.S. Cl. 348/558; 348/556

(57) ABSTRACT

A technique is used for determining a video format for a video output signal generated by a television receiver. The technique includes acquiring a preferred output format that is one of a plurality of video formats and determining an aspect ratio of a selected television signal having one of a plurality of television signal formats. The video output signal is generated using one of the plurality of video formats having a 4:3 aspect ratio when the selected television signal has a television signal format having a 4:3 aspect ratio and the preferred output format is other than one that has only a 4:3 aspect ratio. A related technique additionally acquires an optional override output format for television signals having an aspect ratio of 4:3 that is used to determine when to use the stated the stated video format to generate the video output signal.

### FIELD OF THE INVENTION

The present invention relates generally to television systems, and more particularly to television receivers that generate a video output signal using a received television signal.

### BACKGROUND OF THE INVENTION

There is an increasing availability of video content in Digital Television (DTV) formats, which are defined and offered in a variety of vertical resolutions, aspect ratios, and scan modes. The DTV formats include high definition television (HDTV), enhanced definition television (EDTV), and standard definition television (SDTV) formats. Broadcasters, equipment manufacturers, and consumers are facing a multitude of configuration issues related to broadcasting, receiving, and viewing the video content of both the newer DTV signals and the long enduring analog television signals (which are defined by well known standards such as NTSC and PAL). The term “television signals” as used herein encompasses all such DTV and analog signals.

In a majority of installations that receive television signals and display the video content, the unit that displays the video content is a television set or television monitor that receives one or more video signals generated by a unit that receives the television signal, which is termed herein a television receiver. Well-known examples of television receivers are broadband (or cable) set-top boxes; satellite receiver/decoders; and off-air or over-the-air receiver/decoders. Another example of a receiver that is not so well established but that is predicted to be commonly available soon, is an internet television receiver. Yet another example of a television receiver is a unit that is internally mounted to the television set or monitor but is essentially an independent unit. To further complicate an issue of confusion that is caused to consumers by the variety of formats used for television signals, not all television sets or monitors are capable of supporting all of the DTV broadcast formats. As a consequence many television receivers are designed to perform format conversions to enable the viewer to see the broadcast. Such converted formats often include a permanent black portion, such as in the well known letter box pattern used when 16:9 aspect ratio format is displayed on a 4:3 aspect display.

With the wide range of format and display options for television signal content, multimedia system operators and equipment manufacturers are concerned about minimizing subscriber confusion and phone calls about display issues. Additionally, recognizing the high cost of HD Television sets and monitors, multimedia system operators and equipment manufacturers are concerned about any liability associated with screen/phosphor burn and damage to subscriber display equipment that can result from prolonged video formats that include permanent black portions around the displayed video content. Therefore, there is a need for a television receiver that minimizes user confusion about video format selection while reducing situations in which there are permanent black patterns around the displayed video content.

### BRIEF DESCRIPTION OF THE DRAWINGS

The present invention is illustrated by way of example and not limitation in the accompanying figures, in which like references indicate similar elements, and in which:

FIG. 1 shows a schematic block diagram of a television receiver and television set for receiving and displaying a television signal, in accordance with the preferred embodiment of the present invention.

FIG. 2 is a flowchart that shows some steps of a method used in the television receiver to make video output format decisions, in accordance with the preferred embodiment of the present invention.

FIG. 2 is a flowchart that shows some steps of a method used in the television receiver to make video output format decisions, in accordance with an alternative embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

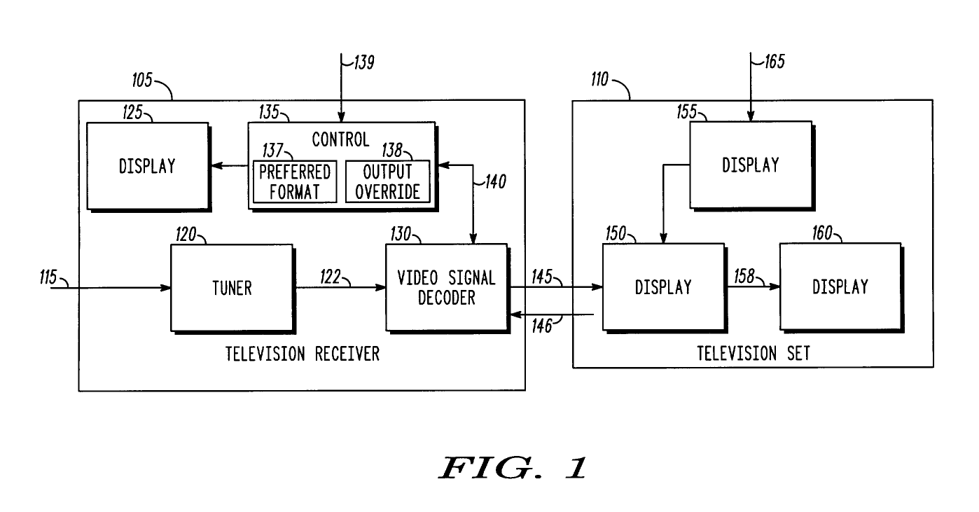

Referring to FIG. 1, a schematic block diagram shows apparatus for receiving and displaying a television signal 122, in accordance with the preferred embodiment of the present invention. The apparatus comprises a television receiver 105 that receives the television signal 122 and generates video output signals 145 that are coupled to a television set 110. The television receiver 105 in the preferred embodiment is a cable television receiver 105 set-top box, but it can be any other device that receives a television signal and generates a video output signal, such as a satellite receiver/decoder or an over-the air receiver/decoder, or a combination of those well known functions. The television signal 122 is a signal that includes video information (also called video content) in a defined standard format, such as the well known NTSC black and white or color signal formats, or one of the well known ATSC digital television (DTV) formats, or a well known PAL format.

In most instances, and in the preferred embodiment of the present invention, the television receiver 105 includes a tuner 120 that selects one television signal 122 from a more complex signal, herein called a broadband signal 115, that includes a plurality of television signals. The broadband signal 115 meets a standard definition for a signal that conveys a plurality of television signals, such as one of the well-known definitions for radio frequency signals for cable distribution, over-the air distribution, or satellite distribution. In accordance with the preferred embodiment, the broadband signal 115 is a cable signal. The broadband signal 115 is coupled to a tuner 120 that selects a desired television signal 122 from the broadband signal, i.e., the television receiver 105 tunes a channel. The television signal 122 is coupled to a video signal decoder 130 that converts the television signal 122 to one or more defined video output signals 145 that are typically used to couple the video content over a short distance such as several meters by wires. Examples of the types of video output signals 145 are those commonly called component video (e.g., YP_{b}Pᵣ OR RGB video), composite video (baseband), RF (e.g., TV channel 2), and S-Video. The video output signals 145 do not necessarily have the same as the format that is used for the television signal 122, and the output formats may differ from output signal to output signal, depending on the physical type of output that is carrying the video output signal. The format that is used for any one of the video output signals 145 is determined by settings of the television receiver 105 that, in accordance with the preferred embodiment, are acquired and maintained by a control section (control) 135 using an interactive setup menu that is presented to the user and modified using inputs generated by the user, such as by an input signal 139 generated from a handheld remote control of a conventional type (not shown in FIG. 1) that is manipulated by the user. The settings are further determined by the format of the selected television signal 122, which is detected by the video signal decoder 130 and coupled to the control section 135 by bidirectional control signal 140. The settings are coupled from the control section 135 to the video signal decoder 130 by bidirectional control signal 140. Among the settings that are acquired by the control section 135 in accordance with the preferred embodiment are a preferred output format (user preferred output format) that is stored in a preferred format register 137 and an optional override output format (optional 4:3 output override) that is stored in a output override register 138. The registers 137, 138 are preferably non-volatile memories.

The setup menu is preferably presented to the user as an on-screen displayed (OSD) menu, in which case the information for the on-screen displayed menu is conveyed in the video output signals 145. In some instances, similar menu information is presented either simultaneously or alternatively on a display 125 that is a portion of the television receiver 105, and that is coupled to the control section 135. In this embodiment, the display 125 is preferably a light emitting diode (LED) display. In an alternative embodiment, the preferred output format and optional override output format settings are determined by switch selections made by the user on switches that are accessible on the television receiver. This can be instead of using an OSD menu or as an alternative method that is available the user. Note that the user can be a consumer or a setup technician. In another embodiment, some of the settings, such as the optional override output format, are maintained by the television set 110 and coupled to the television receiver 105 by a settings signal 146. This embodiment is particularly useful in an instance in which the manufacturer incorporates the functions of receiving the television signal 122 by including the television receiver 105 as a portion of the television set 110. This information 165 may be the setting information, or it may be menu control information from which the settings are determined interactively by the user and an on-screen menu.

It will be appreciated that the functions of the display 125, the control section 135, the tuner 120, and the video signal decoder 130 are preferably implemented in one or more integrated circuits that can include one or more processors that operated using programs stored in memory and can include application specific integrated circuits that may also use processors. One processor may perform portions of one or more of the functions of the display 125, the control section 135, the tuner 120, and the video signal decoder 130.

The television set (or television monitor) 110 comprises a display signal generator 150 that receives the video output signals 145 and convert a selected one of them to display driving signals that are coupled to a video display 160, in a conventional manner. The video display 160 is, for example, a projection cathode ray tube (CRT) display, a direct view CRT display, a liquid crystal display (LCD), or a plasma display. The control section 155 performs many conventional functions, such as receiving and using handheld remote control signals to change setup parameters such as picture brightness, time settings, etc. The television set 110 may also include (not shown) a receiver that receives, for example, only NTSC analog signals from an antenna that intercepts over the air broadcast signals.

An example of a portion of an OSD User Setting menu presented by the television receiver 105 on the television set 110 is shown in Table 1, in accordance with the preferred embodiment of the present invention. Default settings of the options are shown. Settings within parentheses do not appear on the display simultaneously, but contain all alternative values. Brackets around text in Table 2 indicate items that are de-highlighted when the MENU is presented for the first time after the television receiver 105 is installed.

TABLE 1
Television receiver 105 OSD Partial Menu
ON SCREEN DISPLAYED MENU

| | |
|---|---|
| PREFERRED | 480i (480p, 720p, 1080i) |
| OUTPUT FORMAT | |
| {OPTIONAL 4:3 | {OFF (480i, 480p)} |
| OVERRIDE | |
| FORMAT} | |

The well-known designations 1080i, 720p, 480i, 480p are those used in ATSC documents to define scan modes and vertical resolutions of the DTV formats described therein.

Menu de-highlighting is used to “gray out” certain menu items and/or options in cases where they are not applicable or have no effect. De-highlighted menu items are disabled and a user is not able to alter items in a de-highlighted state. Navigational arrows step over de-highlighted items.

When the User Setting menu item PREFERRED OUTPUT FORMAT, is set, to 480i, the television receiver 105:

Stores the current User Setting OPTIONAL 4:3 OVERRIDE FORMAT sub-menu item selection in non-volatile memory

Sets the User Setting OPTIONAL 4:3 OVERRIDE FORMAT sub-menu selection to OFF

De-highlights the OPTIONAL 4:3 OVERRIDE FORMAT sub-menu Item and corresponding option field

When the User Setting menu item PREFERRED OUTPUT FORMAT is changed from 480i to any other mode (480p, 720p, or 1080i), the television receiver 105:

Activates the User Setting menu sub-item OPTIONAL 4:3 OVERRIDE FORMAT on the OSD screen

Restores the previously saved User Setting sub-menu item OPTIONAL 4:3 OVERRIDE FORMAT.

When any menu item, sub-item, or option is de-highlighted, it is not selectable

All menu Navigation functions step over de-highlight menu items.

Default Menu Option Settings

The television receiver 105 employs default values for all user setting options. The defaults are defined in order to maximize the probability of a valid user output setting. The settings defined should produce an output on nearly every type of television set.

Default values for the User setting screen menu item options are stored in television receiver 105 firmware and are set as follows:

PREFERRED OUTPUT FORMAT: 480i

OPTIONAL 4:3 OVERRIDE FORMAT: OFF, De-highlighted (OPTIONAL 4:3 OVERRIDE FORMAT has no meaning when PREFERRED OUTPUT FORMAT is 480i, since the aspect ratio of this format is always 4:3 by definition)

All User setting selections are stored in non-volatile memory, and are retained through power-loss, or firmware upgrades. The design also allows all user settings to be reset to default values.

Preferred Output Format

This menu item allows the user to set the preferred output format of the television receiver 105's YP_{b}Pᵣ physical outputs. Note that this setting is preferably stored independently from a physical setting of the YP_{b}Pᵣ outputs that is maintained by the television receiver 105. This is especially true since the PREFERRED OUTPUT FORMAT User Setting selection may be overridden in certain instances by the television receiver 105. The television receiver 105 uses this information in order to avoid extraneous mode changes that could cause undesirable delays and artifacts. This option selection is also provided on the front panel LEDs, to ensure the user can properly configure the television receiver 105 for an output mode that is compatible with the television set 110 when the format of the video output signals 145 currently in use by the television set 110 are not compatible with the video display 160 of the television set 110.

The television receiver 105 uses the User Setting menu item PREFERRED OUTPUT FORMAT selection to set the component output video line/field format, except when the state of OPTIONAL 4:3 OVERRIDE FORMAT is enabled (refer to the next section for details).

The television receiver 105 stores the current physical setting of the YP_{b}Pᵣ output at all times.

When the User Setting menu item PREFERRED OUTPUT FORMAT has been selected, the television receiver 105 displays a suitable descriptive term for the menu item, as well as the current option selection on the front Panel LED display 125. The LED display 125 is updated to reflect any changes to the options.

Optional Output Override Format

Optional Output Override Format (OPTIONAL 4:3 OVERRIDE FORMAT) provides a user selectable feature to automatically override the User Setting Menu PREFERRED OUTPUT FORMAT selection when a television signal having 4:3 broadcast aspect ratio content is tuned. This mode allows the user to automatically eliminate a postage stamp problem in certain instances. The postage stamp problem would otherwise occur when a television signal is received that has 4:3 aspect ratio video content formatted with black bars included at the left and right of the video content (in order to achieve a 16:9 aspect ratio formatted signal without stretching the video content) and is then modified because of a user selection of a 4:3 video output signal format (to conform to a television set 110 having a 4:3 aspect ratio video display 160) by adding black bars at the top and bottom of the video content. The television receiver 105 maintains the actual physical state of the YP_{b}Pᵣ video outputs in order to avoid extraneous mode changes that could cause undesirable delays and artifacts during the tuning process that generates the selected television signal.

When user setting menu item PREFERRED OUTPUT FORMAT is set to 480i, the OPTIONAL 4:3 OVERRIDE FORMAT feature is disabled.

When user setting menu sub-item OPTIONAL 4:3 OVERRIDE FORMAT is enabled and is set to OFF, the television receiver 105 applies the other current user setting menu item option selections under all conditions.

When user setting menu sub-item OPTIONAL 4:3 OVERRIDE FORMAT is enabled and set to 480i or 480p, then when a channel is selected, the video signal decoder 130 detects the aspect ratio of the selected television signal 122, and the control section 135 determines the user setting menu sub-item OPTIONAL 4:3 OVERRIDE FORMAT selection, and uses this information to determine the YP_{b}Pᵣ Setting as shown in Table 2, barring any other function of the television receiver 105 that further alters the video output signal format. An example of such other function is a TV Type function that imposes yet other rules to determine the video output format. Barring such other functions, the television receiver 105 compares the Video Output (YP_{b}Pᵣ)Setting obtained in Table 2 to the actual physical setting of the YP_{b}Pᵣ outputs. If they are the same, the television receiver 105 retains the physical setting of the YP_{b}Pᵣ outputs. If they are different, the television receiver 105 changes the physical setting and format of the YP_{b}Pᵣ outputs to match the PREFERRED OUTPUT FORMAT. Thus, in Table 2, the Video Output Signal and Aspect Ratio Formatting processing rules apply to the generation of the video output signals, unless there exists another function that imposes yet other rules. In particular, “use the preferred output format” means to use the preferred output format, barring other rules, to generate the video output signal and its aspect ratio.

TABLE 2
OPTIONAL OUTPUT OVERRIDE FORMAT Processing

| | OPTIONAL | | |
|---|---|---|---|
| Current | OUTPUT | | |
| Broadcast | OVERRIDE | Video | Aspect |
| Aspect | FORMAT | Output | Ratio |
| Ratio | Selection | Signal | Formatting |
| 4:3 | 480i | Apply Optional | Apply 4:3 aspect |
| | or | Output Override | ratio |
| | 480p | Format (480i or | |
| | | 480p) | |
| 16:9 | 480i | Use | Use |
| | or | PREFERRED | PREFERRED |
| | 480p | OUTPUT | OUTPUT |
| | | FORMAT | FORMAT |

Output Mode Decision Making Process

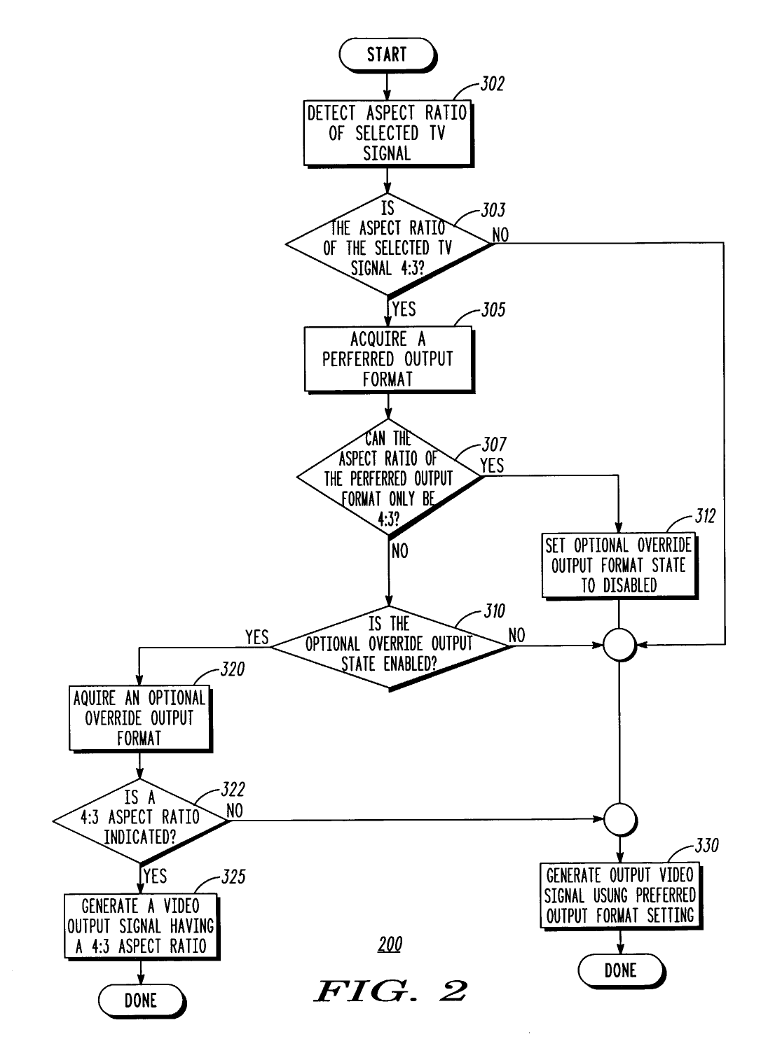

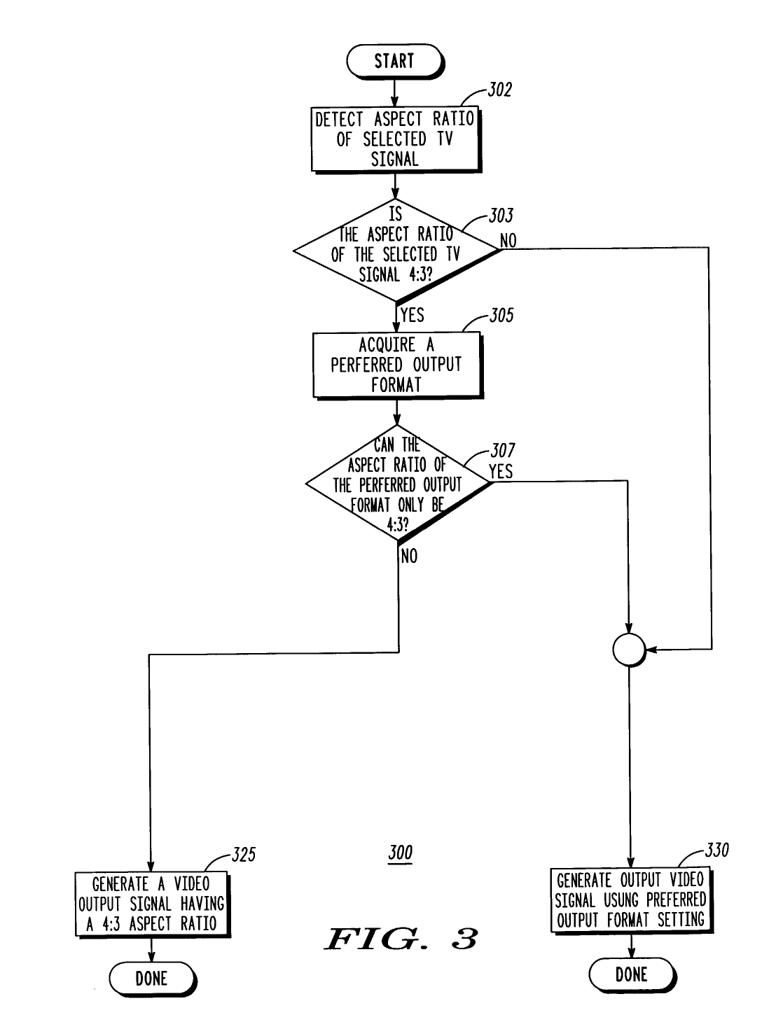

Referring to FIG. 2, a flowchart 200 shows some steps of a method used in the television receiver 105 to make video output format decisions, in accordance with one example of the preferred embodiment of the present invention. Some steps that have been described herein above and some steps that are obvious to one of ordinary skill in the art may not shown in the flow chart, but would be used to implement the television receiver 105. At step 302, the control section 135 detects an aspect ratio of the selected television signal 122, and at step 303 determines whether the aspect ratio is 4:3. When the is aspect ratio of the selected television signal 122 is 4:3 then at step 305, the control section 135 acquires a preferred output format (user preferred output format) for at least one of the video output signals, which in accordance with the preferred embodiment is the Y P_{b} Pᵣ signal. The preferred format, in accordance with the preferred embodiment of the present invention, is one of the DTV formats defined by ATSC. At step 307, the control section determines whether the preferred output format is one that is defined to have only a 4:3 aspect ratio (in the preferred embodiment, whether the preferred output format is set to 480i). When the preferred output format is other than one that is defined to have only a 4:3 aspect ratio (i.e, is not 480i in the preferred embodiment), the control section 135 determines, at step 310, whether the optional override output format state is enabled. In accordance with the preferred embodiment, the optional override output format state is enabled and can be OFF or is enabled and can indicate a 4:3 aspect ratio. In accordance with the preferred embodiment, “the optional override output format state is enabled and can indicate a 4:3 aspect ratio” means the optional override output format is enabled and has a value of 480i or 480p. Hereafter, the statement “the optional override output format indicates a 4:3 aspect ratio” is equivalent to “the optional override output format state is enabled and can indicate a 4:3 aspect ratio”. When the optional override output format state is enabled, then the control section 135 acquires the optional override output format at step 320 and determines whether it indicates a 4:3 aspect ratio (i.e., is 480i or 480p in the preferred embodiment) at step 322. When the optional override output format indicates a 4:3 aspect ratio, the control section 135 couples a signal to the video signal decoder 130 that causes the video signal decoder 130 to generate one of the video output signals 145 using a video format having a 4:3 aspect ratio (i.e., 480p having a 4:3 aspect ratio or 480i, which by definition has only a 4:3 aspect ratio, in the preferred embodiment).

When the aspect ratio of the selected television signal 122 is not 4:3 at step 303, the video signal decoder 130 is controlled by the control section 135 to generate one of the video output signals 145 using the preferred video output format.

When it is determined that the aspect ratio of the preferred output format can only be 4:3 (in accordance with the preferred embodiment, set to 480i) at step 307, the optional override output format state is disabled at step 312 by the control section 135 and the video signal decoder 130 is controlled by the control section 135 to generate one of the video output signals 145 using the preferred video output format.

When the optional override output format state is determined to be disabled at step 310, or when the optional override output format is determined to not indicate a 4:3 aspect ratio at step 322, the video signal decoder 130 is controlled by the control section 135 to generate one of the video output signals 145 using the preferred video output format.

At this point, it can be seen that the video signal decoder 130 generates (step 325) from the selected television signal 122 one of the video output signals 145 using a video format having a 4:3 aspect ratio (i.e., 480p having a 4:3 aspect ratio, or 480i, which has by definition only a 4:3 aspect ratio in the preferred embodiment) when the selected television signal 122 has a television signal format that has a 4:3 aspect ratio (step 303), and the preferred output format is other than one that has only a 4:3 aspect ratio (step 307) and the optional override output format state is an enabled one (step 310) that indicates a 4:3 aspect ratio (step 322). In accordance with the preferred embodiment, the plurality of television signal formats and the plurality of video output signal formats are the set of DTV formats defined by the ATSC and analog formats defined by the NTSC. The benefits of the preferred embodiment of the present invention are that the postage stamp format is avoided, and the possibility of damage to the video display 160 is reduced.

Otherwise, at step 330 the video signal decoder 130 generates one or more of the video output signals 145 using the preferred output format.

In accordance with the embodiment described above with reference to FIG. 2, the statement “the optional override output format state is an enabled one that indicates a 4:3 aspect ratio” is hereafter simplified to “the optional override output format indicates a 4:3 aspect ratio”. In accordance with an alternative embodiment, the optional override output format state is always enabled, and can have a 4:3 aspect ratio (preferably, the optional override output format is enabled and has a value of 480i or 480p). For this alternative embodiment, steps 310 and 312 of the method described with reference to FIG. 2 are eliminated; the NO path from step 307 goes to step 320 and the YES path from step 307 goes to step 330. For this alternative embodiment, it can be seen that the video signal decoder 130 generates (step 325) from the selected television signal 122 one of the video output signals 145 using a video format having a 4:3 aspect ratio (i.e., preferably 480p having a 4:3 aspect ratio or 480i, which by definition has only a 4:3 aspect ratio) when the selected television signal 122 has a television signal format that has a 4:3 aspect ratio (step 303), and the preferred output format is other than one that has only a 4:3 aspect ratio (step 307) and the optional override output format indicates a 4:3 aspect ratio (step 322).

Referring to FIG. 3, a flowchart 300 shows some steps of a method used in the television receiver 105 to make video output format decisions, in accordance with an example of an alternative embodiment of the present invention in which the optional override output format is not used. The method in this alternative embodiment is similar to that described with reference to FIG. 2 except that steps 310, 312, 320, and 322 are eliminated, and the NO path from step 307 goes to step 325, and the YES path from step 307 goes to step 330. The video signal decoder 130 generates (step 325) from the selected television signal 122 one of the video output signals 145 using a video format having a 4:3 aspect ratio (i.e., preferably 480p having a 4:3 aspect ratio or 480i, which by definition has only a 4:3 aspect ratio) when the selected television signal 122 has a television signal format that has a 4:3 aspect ratio (step 303) and the preferred output format is other than one that has only a 4:3 aspect ratio (step 307). In accordance with this alternative embodiment, the plurality of television signal formats and the plurality of video output signal formats are the set of DTV formats defined by the ATSC and analog formats defined by the NTSC. This method requires less interaction with a user, but can present the video content in the less desirable postage stamp format.

It will be appreciated that the benefits of the present invention can be achieved when the above method steps are performed in some different arrangements; i.e., not all the steps are necessarily dependent upon all of the ones that precede them in the particular examples described.

In other alternative embodiments, the format of the video output signal may be determined by additional rules that are applied at steps 325 or 330, but in such cases the format of the at least one video output signal is determined by using the television signal format, the optional override output format and preferred output format (for the preferred embodiment), or the television signal format and preferred output format (for an alternative embodiment) in the manner described herein, and as further determined by such additional rules.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As an example, the benefits of the present invention can be obtained in television receivers used in television systems having formats with other scan rates, or aspect ratios differing from those specifically defined by ATSC, in which a “postage stamp” presentation of the video content arises such as that described above.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

What is claimed is:

1. A method used for determining a video format for a video output signal generated by a television receiver that tunes a selected television signal that has one of a plurality of television signal formats and generates the video output signal having one of a plurality of video formats using the selected television signal, comprising:
acquiring a preferred output format that is one of the plurality of video formats;
acquiring an optional override output format for television signals having an aspect ratio of 4:3;
determining an aspect ratio of a selected television signal having one of the plurality of television signal formats; and
generating the video output signal with a video format having a 4:3 aspect ratio when the selected television signal has a television signal format having a 4:3 aspect ratio and the preferred output format is other than one that has only a 4:3 aspect ratio and the optional override output format indicates a 4:3 aspect ratio.

2. The method according to claim 1, further comprising:
otherwise generating the video output signal using the preferred output format.

3. The method according to claim 1, wherein the acquiring of an optional override output format comprises:
enabling selection of the optional override output format only when an aspect ratio of the preferred output format is not 4:3.

4. The method according to claim 1, wherein the television receiver is one of a cable set-top box and a satellite receiver/decoder and an over-the-air decoder.

5. The method according to claim 1, wherein the selected television signal has one of a National Television Standards Committee defined format and an Advanced Television Standards Committee defined format.

6. The method according to claim 1, wherein the video output signal has one of a National Television Standards Committee defined format and an Advanced Television Standards Committee defined format.

7. The method according to claim 1, wherein the video output signal is generated as one of an RGB component signal and a YP_{b}Pᵣ component signal.

8. The method according to claim 1, wherein one of a menu driven selection technique and a switch selection is used for the acquiring of a preferred output format.

9. The method according to claim 1, wherein one-of a menu driven selection technique and a switch selection and a television set input signal is used for the acquiring of an optional override output format.

10. The method according to claim 1, wherein the optional override output format has a state that is one of enabled and disabled, and wherein in the enabled state, the optional override output format has at least one value that identifies an aspect ratio.

11. A method used for determining a video format for a video output signal generated by a television receiver that tunes a selected television signal that has one of a plurality of television signal formats and generates the video output signal having one of a plurality of video formats using the selected television signal, comprising:
acquiring a preferred output format that is one of the plurality of video formats;
determining an aspect ratio of a selected television signal having one of the plurality of television signal formats; and
generating the video output signal using a video format having a 4:3 aspect ratio when the selected television signal has a television signal format having a 4:3 aspect ratio and the preferred output format is other than one that has only a 4:3 aspect ratio.

12. A method used for determining a video format for a video output signal generated by a television receiver that tunes a selected television signal that has one of a plurality of television signal formats and generates the video output signal having one of a plurality of video formats using the selected television signal, comprising:
acquiring a user preferred output format having one of the plurality of video formats; and
enabling an optional override output format selection only when an aspect ratio of the user preferred output format is not 4:3.

13. A television receiver that uses a selected television signal that has one of a plurality of television signal formats to generate a video output signal having one of a plurality of video formats using the selected television signal, comprising:
a control section that acquires a preferred output format that is one of the plurality of video formats, and acquires an optional override output format for television signals having an aspect ratio of 4:3 and determines an aspect ratio of a selected television signal having one of the plurality of television signal formats; and
a video signal decoder that generates the video output signal from the selected television signal using a video format having a 4:3 aspect ratio when the selected television signal has a television signal format having a 4:3 aspect ratio and the preferred output format is other than one that has only a 4:3 aspect ratio and the optional override output format indicates a 4:3 aspect ratio.

14. The television receiver according to claim 13, wherein the video signal decoder generates the video output signal using the preferred output format when the condition “the selected television signal has a television signal format having a 4:3 aspect ratio and the preferred output format is other than one that has only a 4:3 aspect ratio and the optional override output format indicates a 4:3 aspect ratio” is not true.

15. The television receiver according to claim 13, wherein the television receiver is one of a cable set-top box and a satellite receiver/decoder and an over-the-air decoder.

16. The television receiver according to claim 13, wherein the selected television signal has one of a National Television Standards Committee defined format and an Advanced Television Standards Committee defined format.

17. The television receiver according to claim 13, wherein the video output signal has one of a National Television Standards Committee defined format and an Advancedl Television Standards Committee defined format.

18. The television receiver according to claim 13, wherein the video output signal is generated as one of an RGB component signal and a YP_{b}Pᵣ component signal

19. The television receiver according to claim 13, wherein one of a menu driven selection technique and a switch selection is used for acquiring the preferred output format.

20. The television receiver according to claim 13, wherein one of a menu driven selection technique and a switch selection and an television set input signal is used for the acquiring of the optional override output format.

21. The television receiver according to claim 13, wherein the optional override output format has a state that is one of enabled and disabled, and wherein in the enabled state, the optional override output format has at least one value that identifies an aspect ratio.

22. A television receiver that uses a selected television signal that has one of a plurality of television signal formats to generate a video output signal having one of a plurality of video formats using the selected television signal, comprising:
a control section that acquires a preferred output format that is one of the plurality of video formats; and
a video signal decoder that generates the video output signal from the selected television signal using a format having a 4:3 aspect ratio when the selected television signal has a television signal format having a 4:3 aspect ratio and the preferred output format is other than one that has only a 4:3 aspect ratio.
